(19) United States
(12) Patent Application Publication
(10) Pub. No.: US 2015/0370372 A1
(43) Pub. Date: Dec. 24, 2015

(54) CAPACITIVE TOUCH PANEL HAVING DIELECTRIC STRUCTURES FORMED THEREIN

(71) Applicant: Maxim Integrated Products, Inc., San Jose, CA (US)

(72) Inventors: Richard S. Withers, Sunnyvale, CA (US); Ronald B. Koo, Los Altos, CA (US); David Johnson, Cupertino, CA (US); Stephen C. Gerber, Austin, TX (US)

(21) Appl. No.: 14/743,065

(22) Filed: Jun. 18, 2015

Related U.S. Application Data
(60) Provisional application No. 62/014,761, filed on Jun. 20, 2014.

(51) Int. Cl. G06F 3/044

(52) U.S. Cl. CPC G06F 3/044

(57) ABSTRACT

A capacitive touch panel that includes dielectric structures formed therein to modify capacitive coupling within the touch panel is disclosed. In one or more implementations, the capacitive touch panel includes elongated drive electrodes arranged next to one another and elongated sensor electrodes arranged one next to another across the elongated drive electrodes. The capacitive touch panel also includes a dielectric structure positioned over a sensor electrode to modify capacitive coupling within the capacitive touch panel.

### BACKGROUND

A touch panel is a human machine interface (HMI) that allows an operator of an electronic device to provide input to the device using an instrument such as a finger, a stylus, and so forth. For example, the operator may use his or her finger to manipulate images on an electronic display, such as a display attached to a mobile computing device, a personal computer (PC), or a terminal connected to a network. In some cases, the operator may use two or more fingers simultaneously to provide unique commands, such as a zoom command, executed by moving two fingers away from one another; a shrink command, executed by moving two fingers toward one another; and so forth.

A touch screen is an electronic visual display that incorporates a touch panel overlying a display to detect the presence and/or location of a touch within the display area of the screen. Touch screens are common in devices such as all-in-one computers, tablet computers, satellite navigation devices, gaming devices, and smartphones. A touch screen enables an operator to interact directly with information that is displayed by the display underlying the touch panel, rather than indirectly with a pointer controlled by a mouse or touchpad. Capacitive touch panels are often used with touch screen devices. A capacitive touch panel generally includes an insulator, such as glass, coated with a transparent conductor, such as indium tin oxide (ITO). As the human body is also an electrical conductor, touching the surface of the panel results in a distortion of the panel's electrostatic field, measurable as a change in capacitance.

### SUMMARY

A capacitive touch panel that includes dielectric structures formed therein to modify capacitive coupling within the touch panel is disclosed. In one or more implementations, the capacitive touch panel includes elongated drive electrodes arranged next to one another and elongated sensor electrodes arranged one next to another across the elongated drive electrodes. The capacitive touch panel also includes a dielectric structure positioned over a sensor electrode to modify capacitive coupling within the capacitive touch panel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a top plan view illustrating sensor and drive electrodes for a touch panel having dielectric structures positioned over the sensor electrodes in accordance with an example implementation of the present disclosure.

FIG. 2 is a top plan view illustrating sensor and drive electrodes for a touch panel having dielectric structures positioned over the sensor electrodes in accordance with another example implementation of the present disclosure.

FIG. 3 is a top plan view illustrating sensor and drive electrodes for a touch panel having dielectric structures positioned over the sensor electrodes in accordance with another example implementation of the present disclosure.

FIG. 4 is a diagrammatic illustration of a dielectric structure that comprises multiple dielectric materials.

FIG. 5 is an exploded isometric view illustrating a touch screen assembly incorporating a touch panel having dielectric structures in accordance with an example implementation of the present disclosure.

FIG. 6 is a flow diagram illustrating a method of forming a touch panel in accordance with example implementations of the present disclosure.

### DETAILED DESCRIPTION

Overview

Projected Capacitive Touch (PCT) touch panels comprise touch screens that comprise a matrix of rows and columns of conductive material (e.g., a grid) layered on sheets of glass. In some instances, PCT touch panels employ mutual capacitance technology that utilize mutual capacitive sensors (e.g., capacitors) that are formed by the row electrodes (e.g., traces) and column electrodes (e.g., traces) at each intersection of the grid. However, in some instances, the touch panels may include a large number of “dead zones,” or areas where touch coordinates do not change with touch position and/or where a touch signal is too weak to be measured between adjacent columns, leading to computed touch coordinates having large jumps and discontinuities.

Accordingly, a capacitive touch panel that includes dielectric structures formed therein to modify capacitive coupling within the touch panel is disclosed. The dielectric structures may be utilized to selectively modify the capacitive coupling and/or guide electrostatic displacement fields to increase capacitive coupling with the user's fingers and/or styli, which may increase the sensitivity of the touch panel. Thus, the dielectric structures may be utilized to tailor the spatial dependence of this coupling. In one or more implementations, the capacitive touch panel includes elongated drive electrodes arranged next to one another and elongated sensor electrodes arranged one next to another across the elongated drive electrodes. The capacitive touch panel also includes a dielectric structure positioned over a sensor electrode to modify capacitive coupling within the capacitive touch panel. In one or more implementations, the dielectric structures comprise dielectric materials that may have a thickness ranging from about ten (10) nanometers to about one hundred (100) nanometers.

Example Implementations

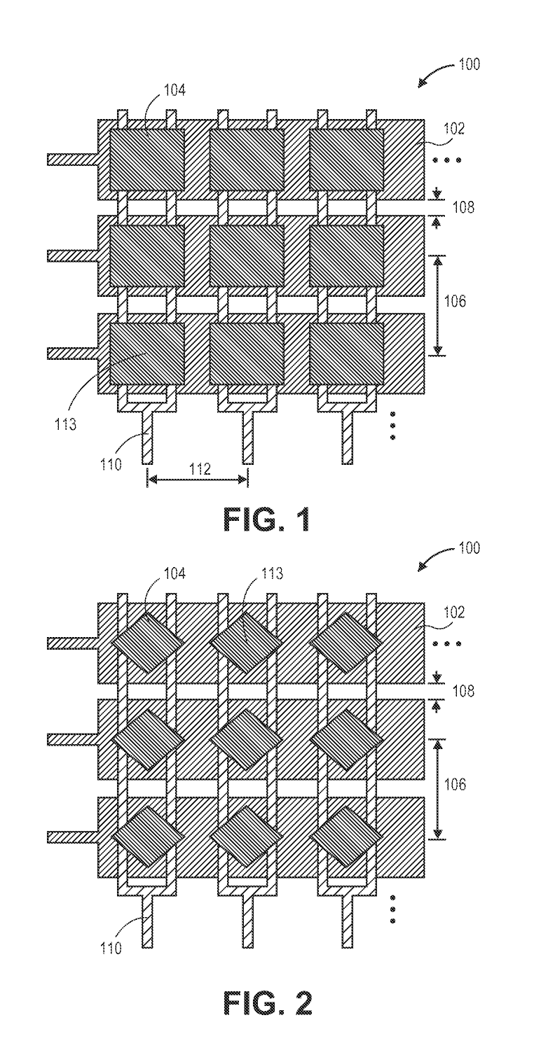

FIGS. 1 through 3 and 5 illustrate example mutual capacitance touch panel 100 in accordance with example implementations of the present disclosure. The capacitive touch panel 100 can be used to interface with electronic devices including, but not necessarily limited to: all-in-one computers, mobile computing devices (e.g., hand-held portable computers, Personal Digital Assistants (PDAs), laptop computers, netbook computers, tablet computers, and so forth), mobile telephone devices (e.g., cellular telephones and smartphones), portable game devices, portable media players, multimedia devices, satellite navigation devices (e.g., Global Positioning System (GPS) navigation devices), e-book reader devices (eReaders), Smart Television (TV) devices, surface computing devices (e.g., table top computers), Personal Computer (PC) devices, as well as with other devices that employ touch-based human interfaces.

The capacitive touch panels 100 may comprise ITO touch panels that include drive electrodes 102, such as cross-bar ITO drive traces/tracks, arranged next to one another (e.g., along parallel tracks, generally parallel tracks, and so forth). In implementations, the drive electrodes 102 can be formed using highly conductive, optically transparent horizontal and/or vertical spines/bars. The bars can reduce the resistance of the row and/or column traces, resulting in reduced phase shifts across the panel and reducing the complexity of the touch controller circuitry. The drive electrodes 102 are elongated (e.g., extending along a longitudinal axis). For example, each drive electrode 102 may extend along an axis on a supporting surface, such as a substrate of a capacitive touch panel 100. The drive electrodes 102 have a pitch 106 (e.g., a substantially repetitive spacing between adjacent axes of the drive electrodes 102). In implementations, the drive electrodes 102 also have a characteristic spacing 108 comprising a minimum distance between adjacent edges of the drive electrodes 102.

The capacitive touch panels 100 also include sensor electrodes 110, such as cross-bar ITO sensor traces/tracks, arranged next to one another across the drive electrodes 102 (e.g., along parallel tracks, generally parallel tracks, and so forth). In implementations, the sensor electrodes 110 can be formed using highly conductive, optically transparent horizontal and/or vertical spines/bars (e.g., as previously described). The sensor electrodes 110 are elongated (e.g., extending along a longitudinal axis). For instance, each sensor electrode 110 may extend along an axis on a supporting surface, such as a substrate of a capacitive touch panel 100. The sensor electrodes 110 have a pitch 112 (e.g., a substantially repetitive spacing between adjacent axes of the sensor electrodes 110). While the sensor electrodes 110 are shown as having a “double-bar” configuration, it is understood that other sensor electrode 110 configurations may be utilized in accordance with the present disclosure (e.g., a “single-bar” configuration, electrodes having protrusions, etc.).

In implementations, the pitch 112 is based upon the touch diameter of a finger. For example, the pitch 112 between adjacent sensor electrodes 110 may be about five millimeters (5 mm) center-to-center. However, a pitch 112 of five millimeters (5 mm) is provided by way of example only and is not meant to be restrictive of the present disclosure. Thus, other implementations may have a pitch 112 of more or less than five millimeters (5 mm).

The drive electrodes 102 and the sensor electrodes 110 define a coordinate system where each coordinate location (pixel 113) comprises a capacitor formed at each intersection between one of the drive electrodes 102 and one of the sensor electrodes 110. Thus, the drive electrodes 102 are configured to be connected to an electrical voltage source (or current source) for generating a local electrostatic field at each capacitor, where a change in the local electrostatic field generated by a finger and/or a stylus at each capacitor causes a decrease in capacitance associated with a touch at the corresponding coordinate location. In this manner, more than one touch can be sensed at differing coordinate locations simultaneously (or at least substantially simultaneously). In implementations, the drive electrodes 102 can be driven by the electrical voltage source (or current source) in parallel, e.g., where a set of different signals are provided to the drive electrodes 102. In other implementations, the drive electrodes 102 can be driven by the electrical voltage source (or current source) in series, e.g., where each drive electrode 102 or subset of drive electrodes 102 is driven one at a time.

As shown in FIGS. 1 through 3, the touch panel 100 includes dielectric structures 104, which are disposed over the sensor electrodes 110. In one or more implementations, the dielectric structure 104 may have a thickness ranging from about ten (10) nanometers to about one hundred (100) nanometers to provide a desired pattern and/or guide electric displacement fields. As shown in FIG. 4, the dielectric structure 104 may comprise multiple layers of dielectric materials. For instance, the dielectric material 104 may include a first dielectric material 104(1), a second dielectric material 104(2), a third dielectric material 104(3), and so forth.

In some implementations, the various dielectric materials may comprise the same dielectric material, differing dielectric material (with respect to one another), or combinations thereof. It is contemplated that the dielectric materials may be selected based upon the requirements of the touch panel 100. In some implementations, the dielectric materials may comprise niobium pentoxide (Nb₂O₅), titanium dioxide (TiO₂), or the like. For instance, dielectric materials may be selected that have a relative dielectric constant ranging from about twenty (20) to about one hundred (100) to provide a desired pattern and/or guide electric displacement fields. However, in some instances, ferroelectrics having higher dielectric constants, such as barium titanate (BaTiO₃) may be utilized. The dielectric materials are selected to modify the capacitive coupling to a desired pattern and/or guide electric displacement fields. Thus, the desired patterns of the capacitive coupling and/or electrostatic fields may dictate the types of dielectric materials selected for the dielectric material 104.

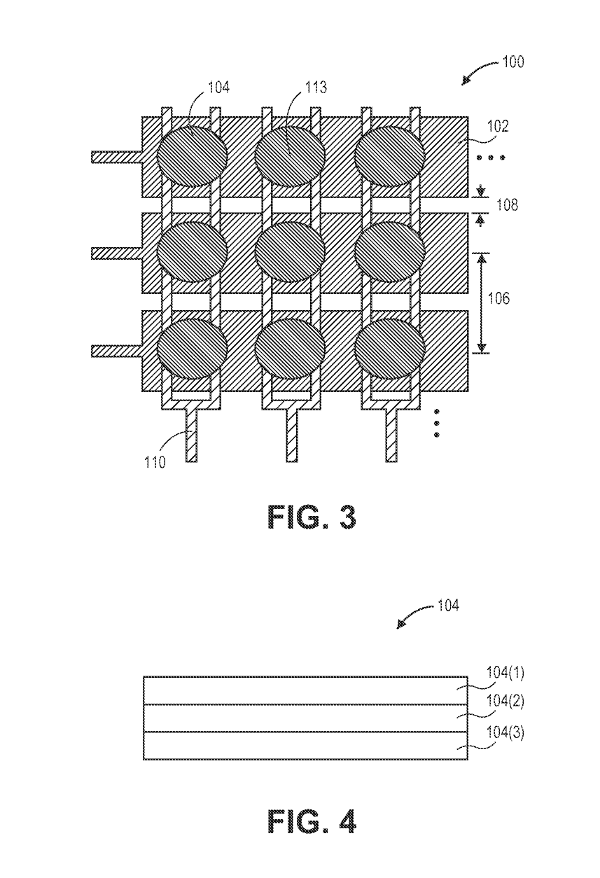

As shown in FIGS. 1 and 2, the dielectric structure 104 may be configured in a variety of ways. For instance, as shown in FIG. 1, the touch panel 100 includes dielectric structures 104 configured in a rectangular configuration, and as shown in FIG. 2, the touch panel includes dielectric structures 104 configured in a diamond configuration. With reference to the diamond configuration shown in FIG. 2, the diamond patterned dielectric structures 104 provide a gradual tapering from the pixel centers 113. The gradual tapering may provide accurate, smooth localization of the electrostatic fields. In another implementation, as shown in FIG. 3, the touch panel 100 includes dielectric structures 104 configured in a circular configuration. It is contemplated that other shapes may be utilized according to the requirements of the design.

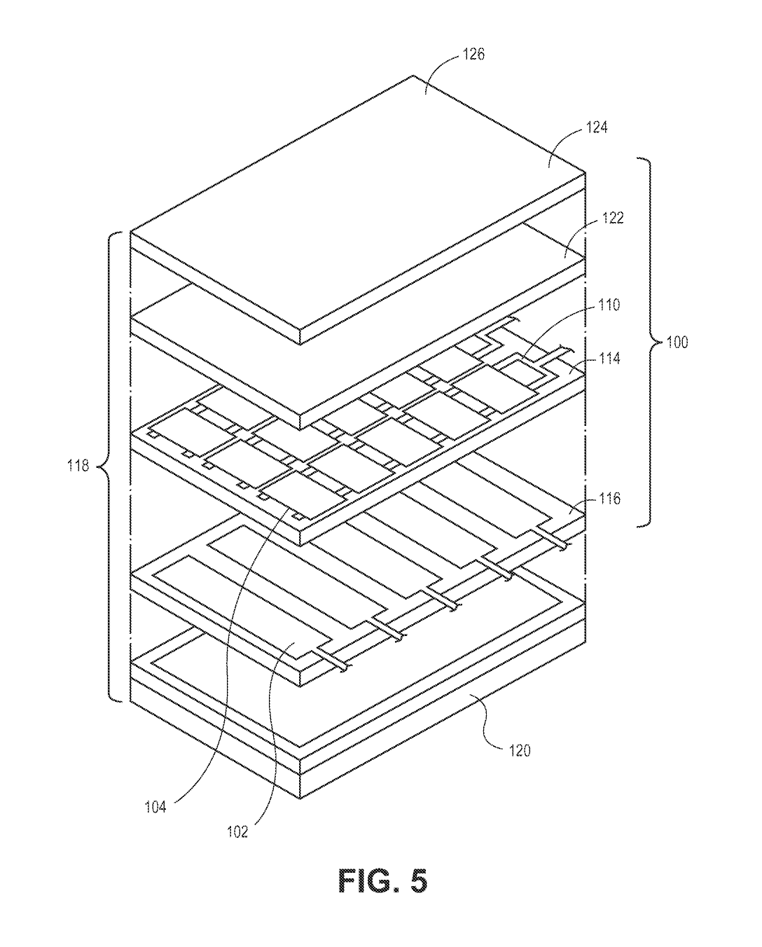

As shown in FIG. 5, the sensor electrodes 110 are electrically insulated from the drive electrodes 102 (e.g., using a dielectric layer, and so forth). For example, the sensor electrodes 110 may be provided on one substrate (e.g., comprising a sensor layer 114 disposed on a glass substrate), and the drive electrodes 102 may be provided on a separate substrate (e.g., comprising a drive layer 116 disposed on another substrate). In this two-layer configuration, the sensor layer 114 can be disposed above the drive layer 116 (e.g., with respect to a touch surface). For example, the sensor layer 114 can be positioned closer to a touch surface than the drive layer 116. However, this configuration is provided by way of example only and is not meant to be restrictive of the present disclosure. Thus, other configurations can be provided where the drive layer 116 is positioned closer to a touch surface than the sensor layer 114, and/or where the sensor layer 114 and the drive layer 116 comprise the same layer.

One or more capacitive touch panels 100 can be included with a touch screen assembly 118. The touch screen assembly 118 may include a display screen, such as an LCD screen 120, where the sensor layer 114 and the drive layer 116 are positioned between the LCD screen 120 and a bonding layer 122, e.g., with a protective cover 124 (e.g., glass) attached thereto. The protective cover 124 may include a protective coating, an anti-reflective coating, and so forth. The protective cover 124 may comprise a touch surface 126, upon which an operator can use one or more fingers, a stylus, and so forth to input commands to the touch screen assembly 118. The commands can be used to manipulate graphics displayed by, for example, the LCD screen 120. Further, the commands can be used as input to an electronic device connected to a capacitive touch panel 100, such as a multimedia device or another electronic device (e.g., as previously described).

Example Process

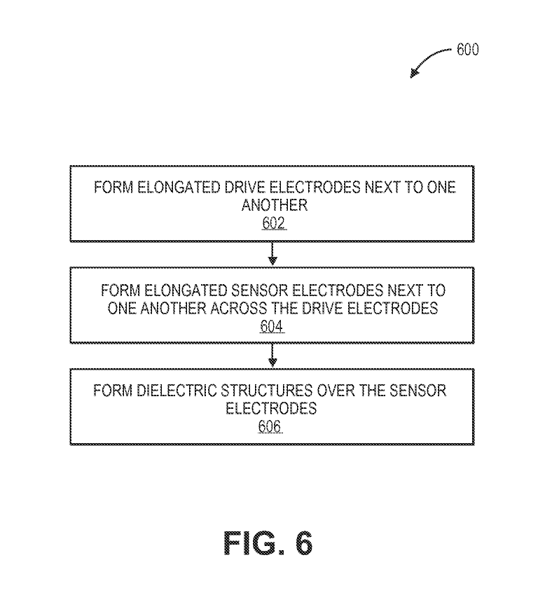

Referring now to FIG. 6, example techniques are described for furnishing capacitive touch panels having dielectric structures formed therein.

FIG. 6 depicts a process 600, in an example implementation, for furnishing a capacitive touch panel, such as the capacitive touch panel 100 illustrated in FIGS. 1 through 5 and described above. In the process 600 illustrated, elongated drive electrodes arranged next to one another are formed (Block 602). For example, with reference to FIGS. 1 through 5, drive electrodes 102, such as cross-bar ITO drive traces/tracks, are arranged next to one another. The drive electrodes 102 can be formed on a substrate of a capacitive touch panel 100 using highly conductive, optically transparent horizontal and/or vertical bars.

Next, elongated sensor electrodes arranged next to one another across the drive electrodes are formed (Block 604). For example, with continuing reference to FIGS. 1 through 5, sensor electrodes 110, such as cross-bar ITO sensor traces/tracks, are arranged next to one another across drive electrodes 102. The sensor electrodes 110 can be formed on a substrate of a capacitive touch panel 100 using highly conductive, optically transparent horizontal and/or vertical bars. Next, as shown in FIG. 6, dielectric structures are formed over the sensor electrodes (Block 606). For example, as shown in FIGS. 1 through 3, multiple dielectric structures 104 are formed over the sensor electrodes 102. In an implementation, the dielectric structures 104 are formed such that the dielectric structures 104 are arranged over the pixel centers 113 of the touch panel 100. In one or more implementations, the dielectric structures 104 are formed utilizing a suitable deposition process. For instance, the dielectric structures 104 may be formed utilizing a suitable thin-film process, a thick-film process, or the like. In an example implementation, the dielectric structures 104 are formed directly over the sensor electrodes 110.

Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A mutual capacitance touch panel comprising:
a plurality of elongated drive electrodes arranged one next to another;
a plurality of elongated sensor electrodes arranged one next to another across the plurality of elongated drive electrodes; and
at least one dielectric structure disposed over at least one sensor electrode of the plurality of sensor electrodes.

2. The mutual capacitance touch panel as recited in claim 1, wherein the plurality of elongated drive electrodes and the plurality of sensor electrodes define a pixel at respective intersections of each drive electrode and each sensor electrode.

3. The mutual capacitance touch panel as recited in claim 2, wherein the at least one dielectric structure is disposed over the sensor electrode at the defined pixel.

4. The mutual capacitance touch panel as recited in claim 1, wherein the at least one dielectric structure is disposed directly over the at least one sensor electrode.

5. The mutual capacitance touch panel as recited in claim 1, wherein the at least one dielectric structure comprises a plurality of dielectric materials.

6. The mutual capacitance touch panel as recited in claim 1, wherein the at least one dielectric structure comprises a single dielectric material.

7. The mutual capacitance touch panel as recited in claim 1, wherein the at least one dielectric structure comprises at least one dielectric material having a relative dielectric constant ranging from about twenty to about one hundred.

8. A method of forming a mutual capacitance touch panel comprising:
forming a plurality of elongated drive electrodes arranged one next to another;
forming a plurality of elongated sensor electrodes arranged one next to another across the plurality of elongated drive electrodes; and
forming at least one dielectric structure over at least one sensor electrode of the plurality of sensor electrodes.

9. The method as recited in claim 8, wherein the plurality of elongated drive electrodes and the plurality of sensor electrodes define a pixel at respective intersections of each drive electrode and each sensor electrode.

10. The method as recited in claim 9, wherein the at least one dielectric structure is disposed over the sensor electrode at the defined pixel.

11. The method as recited in claim 8, wherein the at least one dielectric structure is disposed directly over the at least one sensor electrode.

12. The method as recited in claim 8, wherein the at least one dielectric structure comprises a plurality of dielectric materials.

13. The method as recited in claim 8, wherein the at least one dielectric structure comprises a single dielectric material.

14. The method as recited in claim 8, the wherein the at least one dielectric structure comprises at least one dielectric material having a relative dielectric constant ranging from about twenty (20) to about one hundred (100).

15. A mutual capacitance touch panel comprising:
a plurality of elongated drive electrodes arranged one next to another;
a plurality of elongated sensor electrodes arranged one next to another across the plurality of elongated drive electrodes, the plurality of elongated drive electrodes and the plurality of sensor electrodes defining a pixel at respective intersections of each elongated drive electrode and each elongated sensor electrode; and
a plurality of dielectric structures disposed over respective intersections.

16. The mutual capacitance touch panel as recited in claim 15, wherein a respective dielectric structure of the plurality of dielectric structures gradually tapers with respect to a corresponding intersection.

17. The mutual capacitance touch panel as recited in claim 15, wherein the at least one dielectric structure is disposed directly over the at least one elongated sensor electrode.

18. The mutual capacitance touch panel as recited in claim 15, wherein the at least one dielectric structure comprises a plurality of dielectric materials.

19. The mutual capacitance touch panel as recited in claim 15, wherein the at least one dielectric structure comprises a single dielectric material.

20. The mutual capacitance touch panel as recited in claim 15, wherein the at least one dielectric structure comprises at least one dielectric material having a relative dielectric constant ranging from about twenty (20) to about one hundred (100).
